(19) United States
(12) Patent Application Publication
(10) Pub. No.: US 2024/0054357 A1
(43) Pub. Date: Feb. 15, 2024

(54) MACHINE LEARNING (ML) DATA INPUT CONFIGURATION AND REPORTING

(71) Applicant: QUALCOMM Incorporated, San Diego, CA (US)

(72) Inventors: Rajeev KUMAR, San Diego, CA (US); Gavin Bernard HORN, La Jolla, CA (US); Xipeng ZHU, San Diego, CA (US); Shankar KRISHNAN, San Diego, CA (US); Aziz GHOLMIEH, Del Mar, CA (US)

(21) Appl. No.: 17/885,144

(22) Filed: Aug. 10, 2022

(51) Int. Cl. G06N 5/02

(52) U.S. Cl. CPC G06N 5/022; H04W 88/02

(57) ABSTRACT

Certain aspects of the present disclosure provide techniques for wireless communications by a user equipment (UE). The UE receives a configuration for at least one machine learning function name (MLFN). The UE receives machine learning (ML) data associated with the at least one MLFN. The UE uses the ML data as an input for at least one of: operation or training of an ML model associated with the at least one MLFN.

### BACKGROUND

### Field of the Disclosure

Aspects of the present disclosure relate to wireless communications, and more particularly, to techniques for machine learning (ML) data input configuration and reporting.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving a configuration for at least one machine learning function name (MLFN); receiving machine learning (ML) data associated with the at least one MLFN; and using the ML data as an input for at least one of: operation or training of an ML model associated with the at least one MLFN.

Another aspect provides a method for wireless communications by a network entity. The method includes transmitting a configuration for at least one MLFN to at least one UE; determining ML data associated with the at least one MLFN to be used as an input for at least one of: operation or training of an ML model associated with the at least one MLFN; and transmitting the ML data to the at least one UE.

Another aspect provides a method for wireless communications by a UE. The method includes transmitting UE capability information to a network entity; receiving from the network entity a configuration for at least one MLFN and a request for ML data associated with the at least one MLFN to be used as an input for at least one of: operation or training of an ML model associated with the at least one MLFN, wherein the configuration and the request are based on the UE capability information; and transmitting the ML data to the network entity in response to the request.

Another aspect provides a method for wireless communications by a network entity. The method includes receiving UE capability information from a UE; transmitting to the UE a configuration for at least one MLFN and a request for ML data associated with the at least one MLFN to be used as an input for at least one of: operation or training of an ML model associated with the at least one MLFN, wherein the configuration and the request are based on the UE capability information; and receiving the ML data from the UE in response to the request

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts a process flow diagram illustrating example communication between multiple UEs and a network entity.

FIG. 6 depicts a process flow diagram illustrating example communication between a UE and a network entity.

FIG. 7 depicts a process flow diagram illustrating example communication between a UE and a network entity.

FIG. 8 depicts a method for wireless communications by a UE.

FIG. 9 depicts a method for wireless communications by a network entity.

FIG. 10 depicts a process flow diagram illustrating example communication between a UE and a network entity.

FIG. 11 depicts a method for wireless communications by a UE.

FIG. 12 depicts a method for wireless communications by a network entity.

FIG. 13 depict aspects of example communications device.

### DETAILED DESCRIPTION

Aspects of the present disclosure provide apparatuses, methods, processing systems, and computer-readable mediums for machine learning (ML) data input configuration and reporting.

User equipment (UE) and network entity vendors may develop ML models for different UE and network entity settings/configurations (e.g., a number of antennas). In some cases, for ML model development and training phase, the UE may need to signal setting/configuration of the UE to the network entity so that the network entity can label ML data for a given UE and network entity setting/configuration. The network entity may also need to signal setting/configuration of the network entity to the UE so that the UE can label the ML data for a given network entity and UE setting/configuration. In some cases, for ML model operation (e.g., running) phase, input ML data may be required for running the ML model. In some cases, input control may also be required to evaluate key performance indicators (KPIs) of the ML model, during the running of the ML model, to determine decisions related to switching the ML model, monitoring the ML model, and/or training the ML model.

Techniques proposed herein provide signaling designs for ML data input configuration and reporting to a network entity and/or a UE. In one example, information/ML data signaled by the network entity or the UE may assist in operation of ML model at the UE or the network entity. In another example, information/training data signaled by the network entity or the UE may assist in labelling training data at the UE or the network entity. The signaling techniques proposed herein are able to assist in operation and/or training of the ML model.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

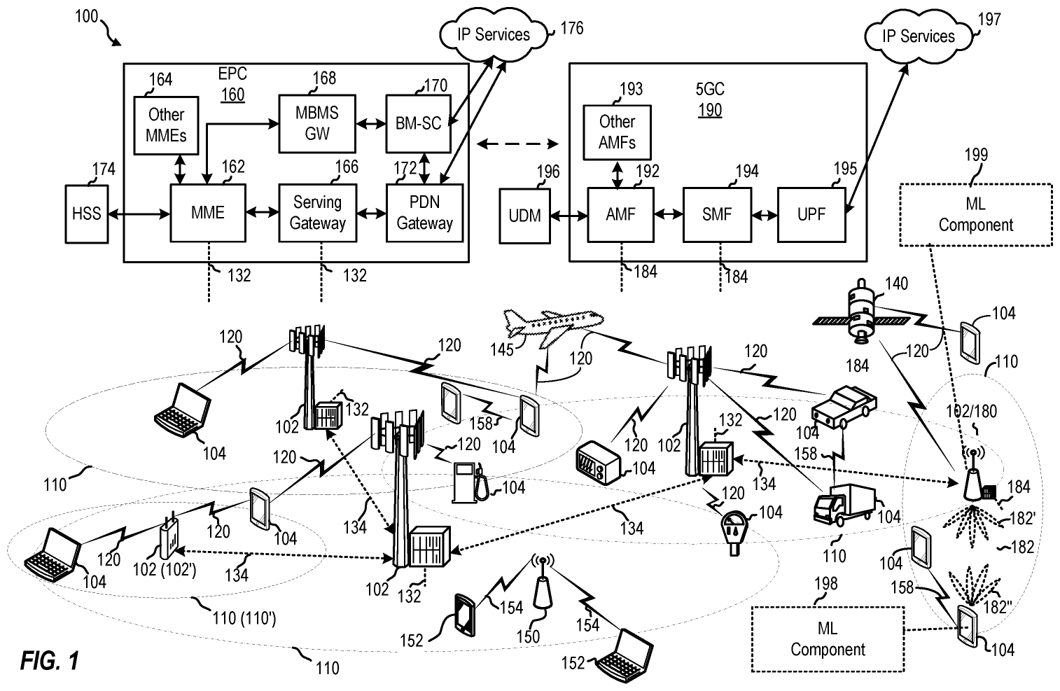

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

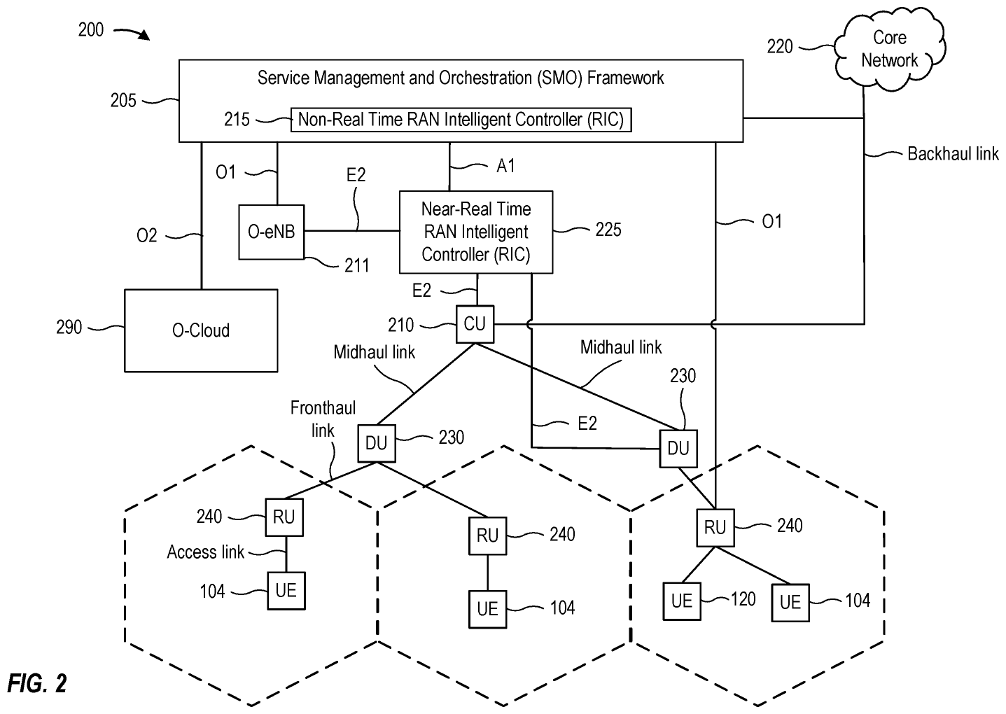

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (MC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

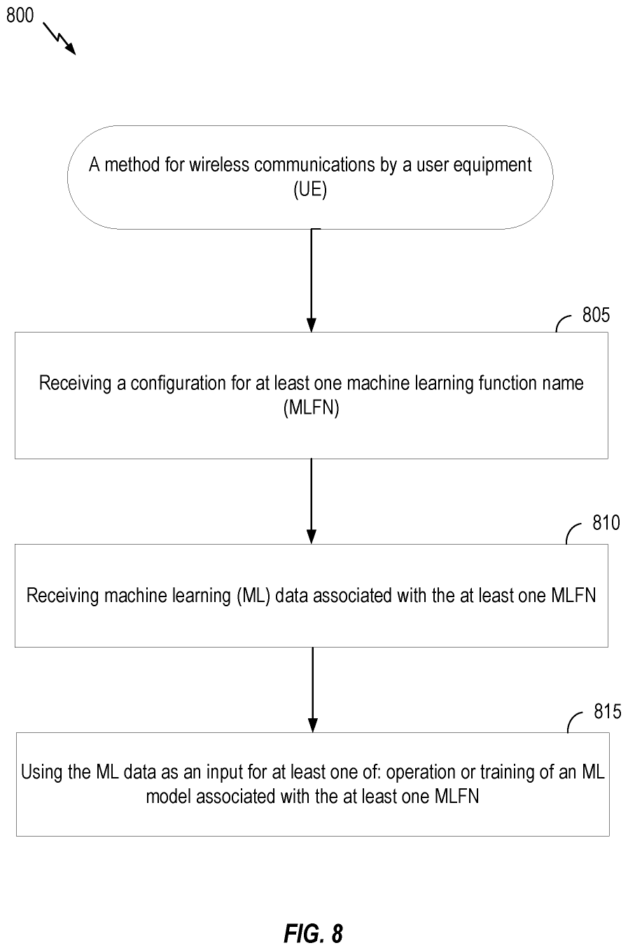

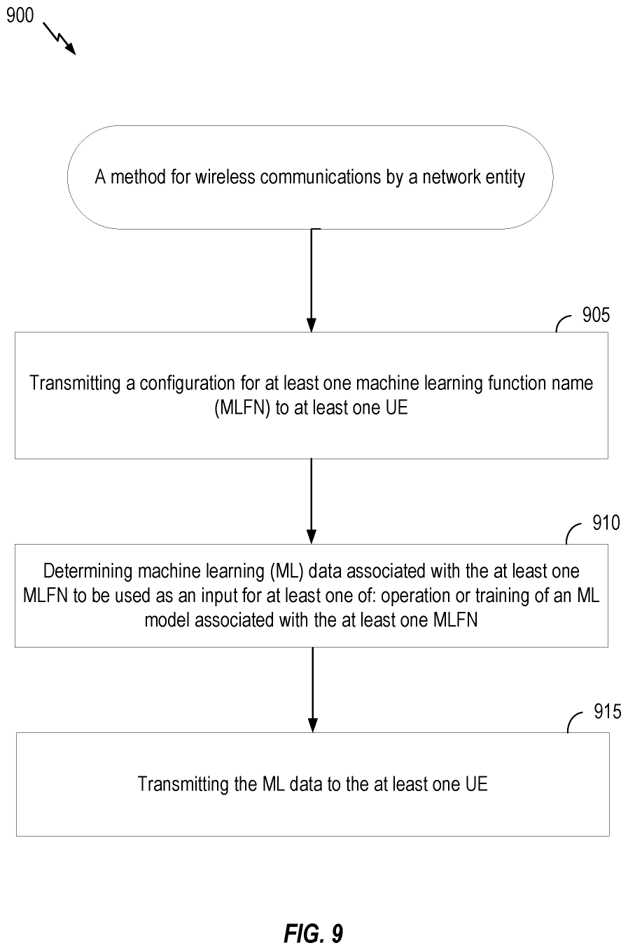

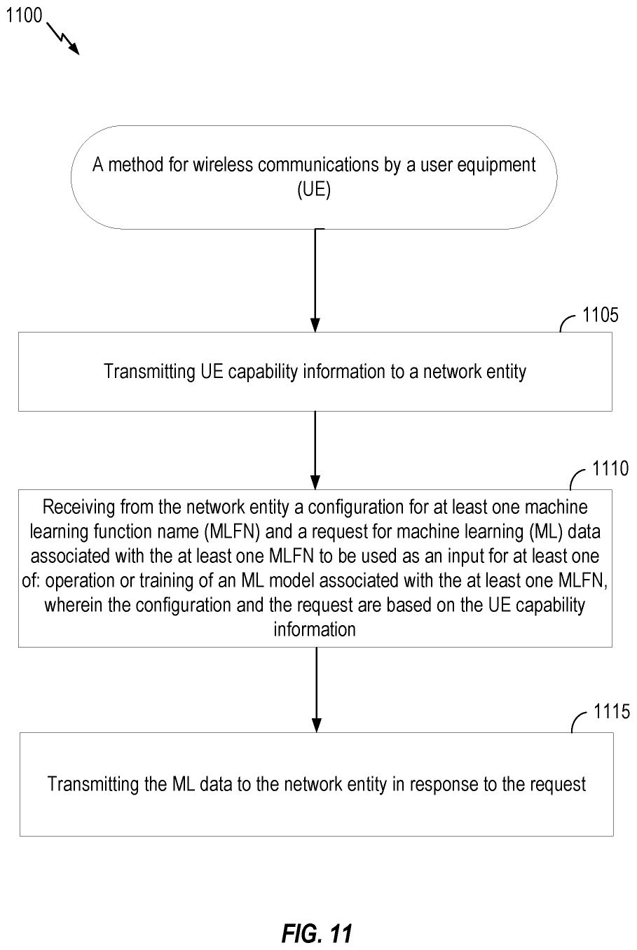

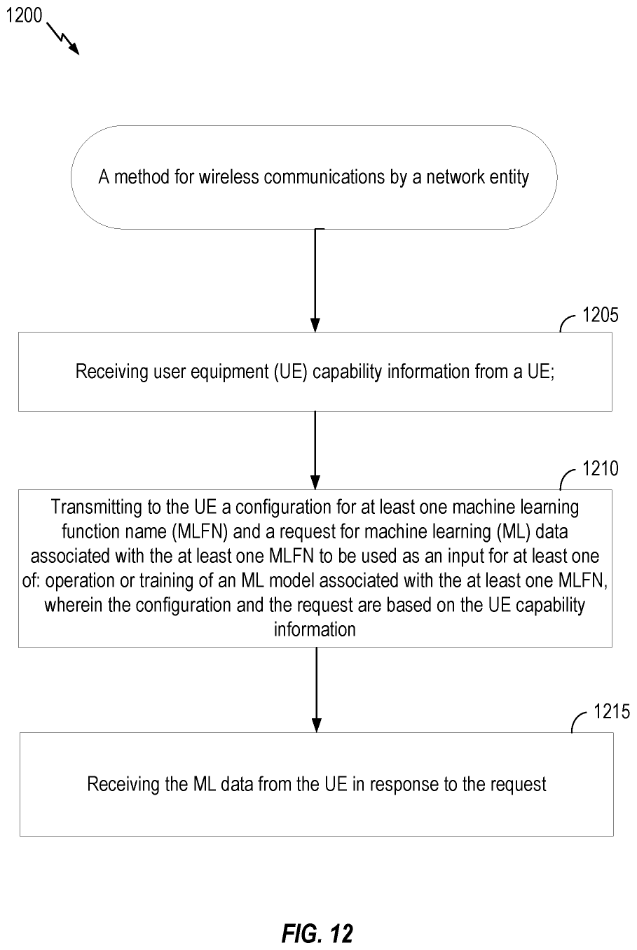

Wireless communication network 100 further includes machine learning (ML) component 198, which may be configured to perform operations 800 of FIG. 8 and/or operations 1100 of FIG. 11. Wireless communication network 100 further includes ML component 199, which may be configured to perform operations 900 of FIG. 9 and/or operations 1200 of FIG. 12.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3r d Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AUML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT MC 215 or the Near-RT MC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as AI policies).

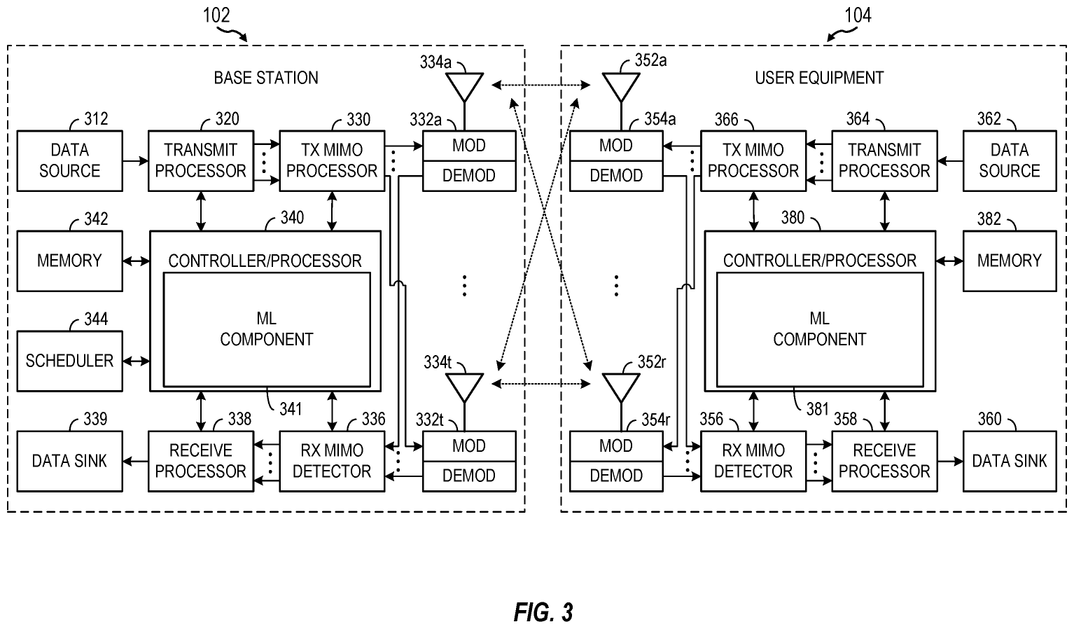

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes ML component 341, which may be representative of ML component 199 of FIG. 1. Notably, while depicted as an aspect of controller/processor 340, ML component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes ML component 381, which may be representative of ML component 198 of FIG. 1. Notably, while depicted as an aspect of controller/processor 380, ML component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

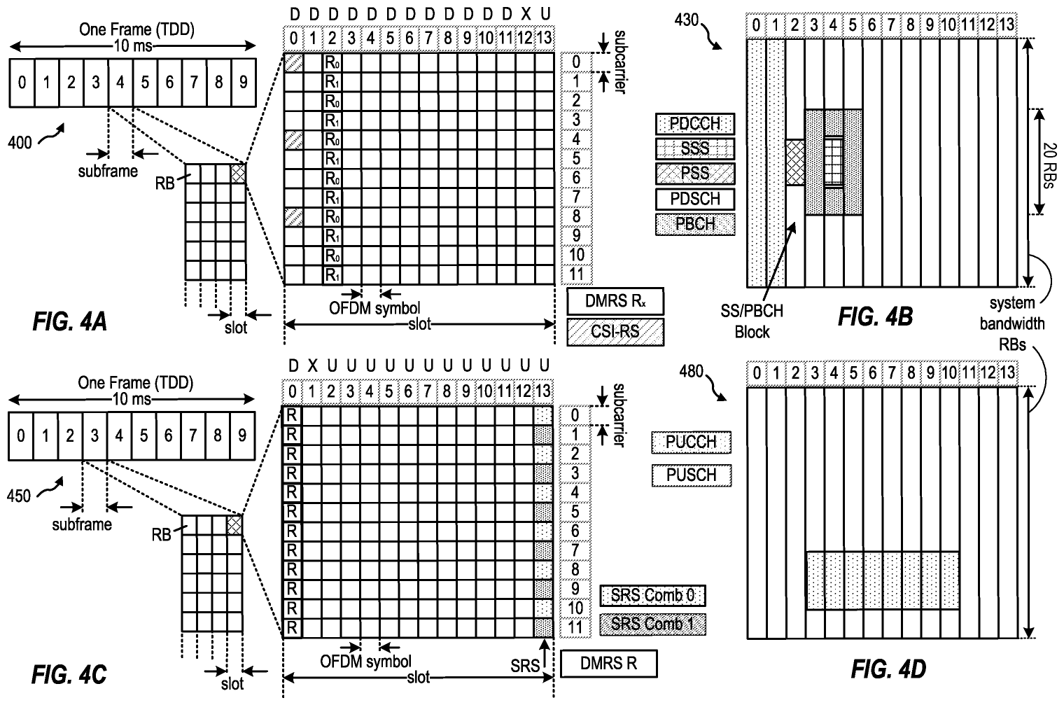

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence (AI)/Machine Learning (ML) Based-Procedure

User equipment (UE) and network entity vendors may develop one or more machine learning (ML) models, model structures (MSs), and/or parameter sets (PSs) per machine learning function name (MLFN). This may be done because a modem and/or a hardware accelerator of a UE and/or a network entity has a limited memory.

The UE and network entity vendors may develop ML models for different UE and network entity settings/configurations (e.g., a number of antennas). In some cases, for ML model development and training phase, the UE may need to signal setting/configuration of the UE to the network entity so that the network entity can label ML data for a given UE and network entity setting/configuration. The network entity may also need to signal setting/configuration of the network entity to the UE so that the UE can label the ML data for a given network entity and UE setting/configuration. In some cases, for ML model operation (e.g., running) phase, input ML data may be required for running the ML model. In some cases, input control may also be required to evaluate key performance indicators (KPIs) of the ML model, during the running of the ML model, to determine decisions related to switching the ML model, monitoring the ML model, and/or training the ML model.

### Aspects Related to Network-Based Machine Learning (ML) Data Input

Aspects of the present disclosure provide apparatuses, methods, processing systems, and computer-readable mediums for network-based machine learning (ML) data input configuration and reporting.

For example, techniques proposed herein provide signaling designs for the network-based ML data input configuration and reporting. In one example, network-based ML data signaled by the network entity to the UE may assist in operation of ML model at the UE. In another example, network-based ML training data signaled by the network entity to the UE may assist in labelling network-based ML training data at the UE. The signaling techniques proposed herein are able to assist in operation and/or training of the ML model at the UE.

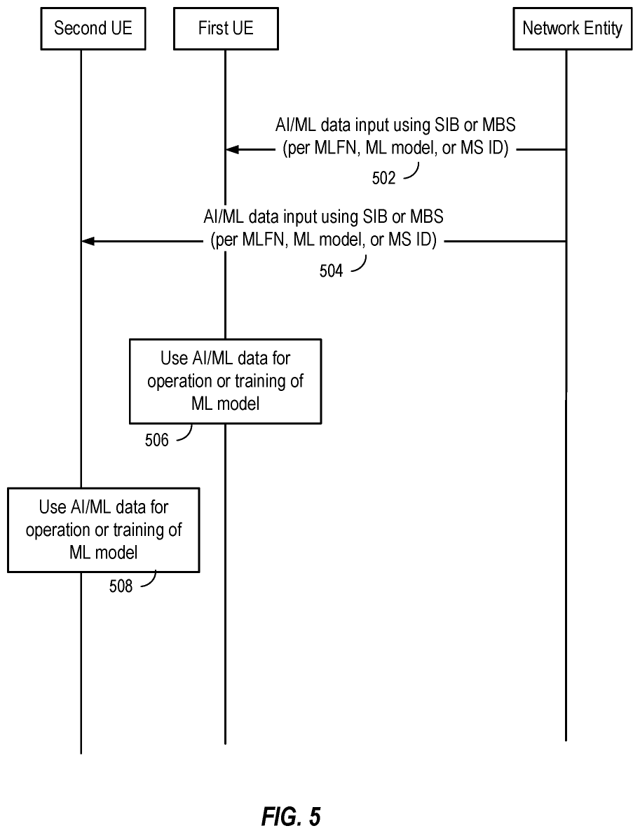

The techniques proposed herein may be understood with reference to the FIGS. 5-9.

FIG. 5 depicts a process flow for communications between a network entity, a first UE and a second UE. In some aspects, the network entity may be an example of the BS 102 depicted and described with respect to FIGS. 1 and 3 or a disaggregated BS depicted and described with respect to FIG. 2. Similarly, the first UE and/or the second UE may be an example of UE 104 depicted and described with respect to FIGS. 1 and 3. However, in other aspects, UE 104 may be another type of wireless communications device and BS 102 may be another type of network entity or network node, such as those described herein.

The first UE and the second UE are in a coverage area of the network entity. The network entity configures the first UE and the second UE with a same machine learning function name (MLFN), ML model identification (ID), and/or model structure (MS) ID. The network entity may broadcast common parameters (e.g., non-UE specific artificial intelligence (AI)/ML data) to the first UE and the second UE.

At 502, the network entity transmits AI/ML data input (e.g., per MLFN, ML model ID, or MS ID) to the first UE. In one example, the network entity may transmit the AI/ML data input to the first UE via system information block (SIB). In another example, the network entity may transmit the AI/ML data input to the first UE via multicast broadcast service (MBS) over MBS channel.

In certain aspects, information provided by the network entity may be used to assist in operation of at least one ML model at the first UE and/or the network entity. For example, AI/ML data may be used as an input to run the ML model (e.g., input parameters to inference), switch the ML model (e.g., auxiliary information or meta data to enable MS or parameter set (PS) switching during inference), monitor the ML model (e.g., ground truth to determine if MS or PS is operating correctly), and/or train the ML model (e.g., ground truth to update the PS). One example of the AI/ML data (e.g., model management data) may include network or UE configuration information such as a number of antennas and a maximum number of retransmissions. The model management data may be used for operating the ML model. Another example of the AI/ML data (e.g., training data) may include actual data such as a network load and/or event thresholds. The training data may be used for training the ML model.

In certain aspects, information provided by the network entity may be used to assist in labelling training data at the first UE and/or the network entity. In some cases, the first UE may include such information as part of a data collection procedure to assist in offline training of ML model.

At 504, the network entity transmits the AI/ML data input to the second UE. In one example, the network entity may transmit the AI/ML data input to the second UE via the SIB. In another example, the network entity may transmit the AI/ML data input to the second UE via the MBS over the MBS channel.

At 506, the first UE uses the received AI/ML data as the input for the operation and/or training of the ML model.

At 508, the second UE use the received AI/ML data as the input for the operation and/or training of the ML model.

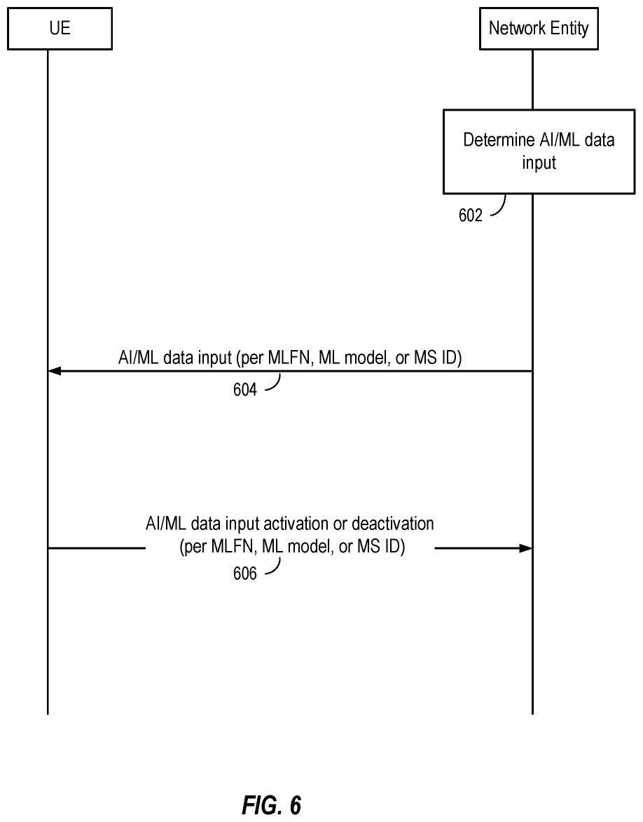

As illustrated in FIG. 6, at 602, a network entity determines AI/ML data input. For example, the network entity may determine UE-specific AI/ML data input that can be sent to a UE in a unicast message.

At 604, the network entity transmits the determined AI/ML data input (e.g., per MLFN, ML model ID, or MS ID) to the UE. In one example, the network entity may transmit the determined AI/ML data input (e.g., for labelling AI/ML training data) to the UE, when the UE connects to the network entity. In another example, the network entity may transmit the determined AI/ML data input (e.g., for operation of ML model) to the UE, when the UE is configured with the MLFN, the ML model ID, or the MS ID. The UE may use the received AI/ML data as an input for the operation and/or training of the ML model.

At 606, the UE transmits the AI/ML data input activation or deactivation indication to the network entity. The UE may transmit the AI/ML data input activation or deactivation indication using a medium access control (MAC) control element (CE), UE assistance information (UAI), and/or uplink control information (UCI). In one example, the UE may send the indication to activate transmission of the AI/ML data input from the network entity based on one or more first requirements of the UE. In another example, the UE may send the indication to deactivate transmission of the AI/ML data input from the network entity based on one or more second requirements of the UE.

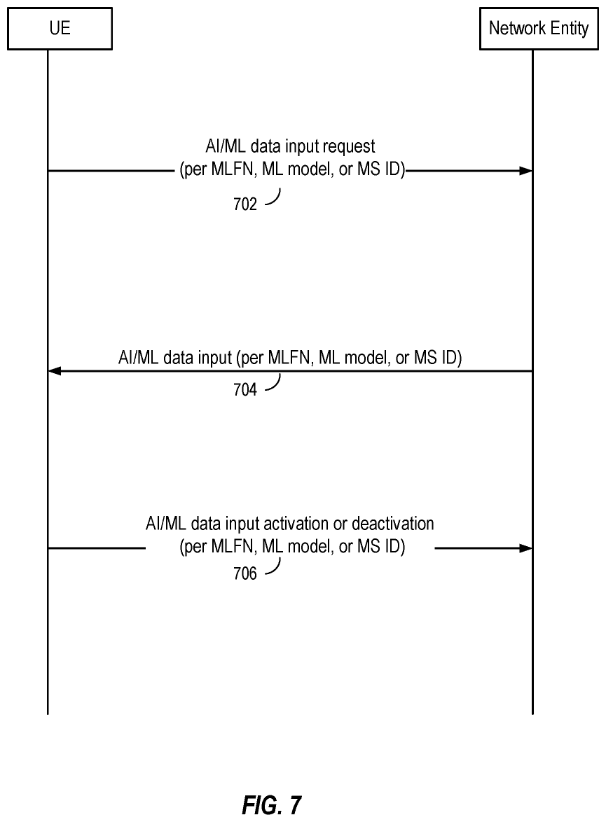

As illustrated in FIG. 7, at 702, a UE transmits AI/ML data input request (e.g., per MLFN, ML model ID, or MS ID) to a network entity. In one example, the UE may transmit the AI/ML data input request to the network entity via UE assistance information (UAI). In another example, the UE may transmit the AI/ML data input request to the network entity via a subscribe request.

In one example, the AI/ML data input request may include MLFN for which AI/ML data input is requested. In another example, the AI/ML data input request may include ML model ID for which the AI/ML data input is requested. In another example, the AI/ML data input request may include MS ID for which the AI/ML data input is requested. In another example, the AI/ML data input request may include geographical information such as current geographical area of the UE, a public land mobile network (PLMN), cell information, and/or a frequency list. In another example, the AI/ML data input request may include a validity time such as a duration time and/or an interval time at which the AI/ML data input has to be provided to the UE by the network entity. In another example, the AI/ML data input request may include one or more network configurations. In another example, the AI/ML data input request may include one or more network settings. In another example, the AI/ML data input request may include a type of the AI/ML data input such as meta data, training data, and/or inference data.

At 704, the network entity transmits the AI/ML data input to the UE. In one example, the network entity may transmit the AI/ML data input to the UE via SIB. In another example, the network entity may transmit the AI/ML data input to the UE via MB S over MB S channel.

At 706, the UE transmits the AI/ML data input activation or deactivation indication to the network entity. The UE may transmit the AI/ML data input activation or deactivation indication using MAC CE, UAI, and/or UCI. In one example, the UE may send the indication to activate transmission of the AI/ML data input from the network entity to the UE based on one or more first requirements of the UE. In another example, the UE may send the indication to deactivate transmission of the AI/ML data input from the network entity to the UE based on one or more second requirements of the UE.

In certain aspects, the network entity may store the AI/ML data input request received from the UE (e.g., at least until the geographical information and the validity time remains valid), and then transfer the AI/ML data input request to another network entity (e.g., during UE context setup, modification, and/or retrieve procedures). For example, the network entity may transfer the AI/ML data input request to another network entity when one or more conditions are satisfied. In one example, the one or more conditions may be satisfied when the UE moves from a connected state to an idle or inactive state. In another example, the one or more conditions may be satisfied when the UE moves from the idle or inactive state to the connected state.

FIG. 8 shows an example of a method 800 for wireless communications by a UE, such as UE 104 of FIGS. 1 and 3.

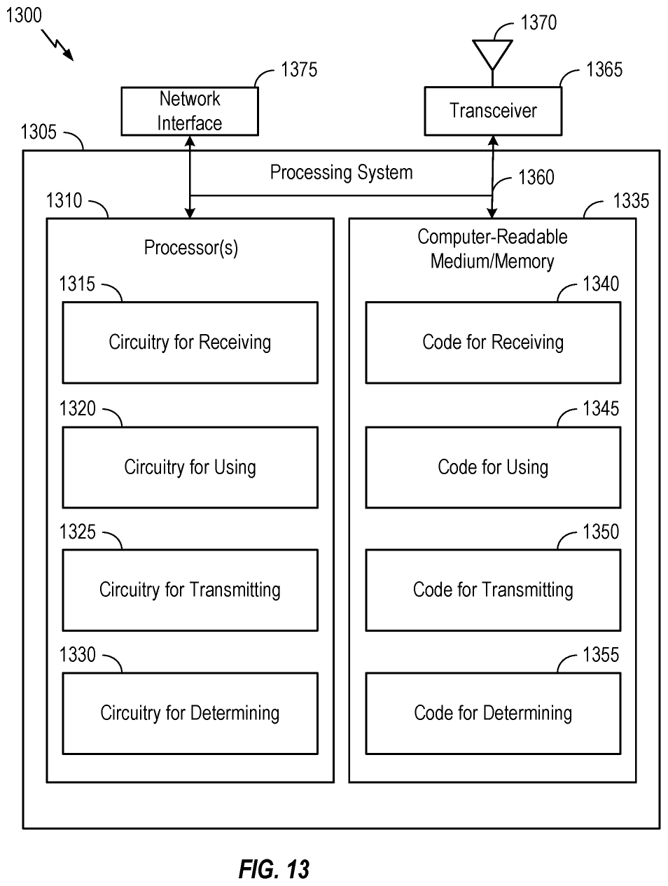

Method 800 begins at step 805 with receiving a configuration for at least one MLFN. In some cases, the operations of this step refer to, or may be performed by, circuitry for receiving and/or code for receiving as described with reference to FIG. 13.

Method 800 then proceeds to step 810 with receiving ML data associated with the at least one MLFN. In some cases, the operations of this step refer to, or may be performed by, circuitry for receiving and/or code for receiving as described with reference to FIG. 13.

Method 800 then proceeds to step 815 with using the ML data as an input for at least one of: operation or training of an ML model associated with the at least one MLFN. In some cases, the operations of this step refer to, or may be performed by, circuitry for using and/or code for using as described with reference to FIG. 13.

In some aspects, the operation of the ML model corresponds to at least one of: running the ML model, switching the ML model, or monitoring the ML model; and the training of the ML model comprises labeling the ML data for a particular UE and network entity setting or configuration and performing the training of the ML model using the labeled ML data.

In some aspects, the ML data comprises model management data and training data; the model management data indicates at least one of: a number of antennas or a number of retransmissions; and the training data indicates at least one of: a network load, an event threshold, or L1 and L2 measurements.

In some aspects, the ML data is applicable for one or more other UEs in a network entity coverage or target area, and the ML data indicates at least one of: an ML model ID or a MS ID together with the ML data.

In some aspects, the ML data is received via at least one of: a SIB or MBS over MBS channel.

In some aspects, the ML data is received via a unicast message when at least one condition is satisfied: the UE connects to a network entity; or the UE is configured with at least one of: the at least one MLFN, an ML model ID, or a MS ID.

In some aspects, the method 800 further includes transmitting an indication using a MAC-CE, UAI, or UCI to the network entity to activate or deactivate transmission of the ML data to the UE. In some cases, the operations of this step refer to, or may be performed by, circuitry for transmitting and/or code for transmitting as described with reference to FIG. 13.

In some aspects, the method 800 further includes transmitting a request to a network entity for the ML data; and the ML data is received in response to the request. In some cases, the operations of this step refer to, or may be performed by, circuitry for transmitting and/or code for transmitting as described with reference to FIG. 13.

In some aspects, the transmitting comprises transmitting the request via at least one of: UAI or a subscribe request.

In some aspects, the request indicates at least one of: the at least one MLFN; an ML model ID; a MS ID; geographical information comprising at least one of: current geographical area of the UE, a PLMN, cell information, or a frequency list; a validity time comprising at least one of: a duration time or an interval time at which the ML data has to be provided to the UE; one or more network configurations or settings; or a type of the ML data comprising at least one of: meta data, training data, or inference data.

In some aspects, the method 800 further includes transmitting an indication using a MAC-CE, UAI, or UCI to the network entity to activate or deactivate transmission of the ML data to the UE. In some cases, the operations of this step refer to, or may be performed by, circuitry for transmitting and/or code for transmitting as described with reference to FIG. 13.

In one aspect, method 800, or any aspect related to it, may be performed by an apparatus, such as communications device 1300 of FIG. 13, which includes various components operable, configured, or adapted to perform the method 800. Communications device 1300 is described below in further detail.

Note that FIG. 8 is just one example of a method, and other methods including fewer, additional, or alternative steps are possible consistent with this disclosure.

FIG. 9 shows an example of a method 900 for wireless communications by a network entity, such as BS 102 of FIGS. 1 and 3, or a disaggregated BS as discussed with respect to FIG. 2.

Method 900 begins at step 905 with transmitting a configuration for at least one MLFN to at least one UE. In some cases, the operations of this step refer to, or may be performed by, circuitry for transmitting and/or code for transmitting as described with reference to FIG. 13.

Method 900 then proceeds to step 910 with determining ML data associated with the at least one MLFN to be used as an input for at least one of: operation or training of an ML model associated with the at least one MLFN. In some cases, the operations of this step refer to, or may be performed by, circuitry for determining and/or code for determining as described with reference to FIG. 13.

Method 900 then proceeds to step 915 with transmitting the ML data to the at least one UE. In some cases, the operations of this step refer to, or may be performed by, circuitry for transmitting and/or code for transmitting as described with reference to FIG. 13.

In some aspects, the operation of the ML model comprises at least one of: running the ML model, switching the ML model, or monitoring the ML model; the training of the ML model comprises labeling the ML data for a particular UE and network entity setting or configuration and performing the training of the ML model using the labeled ML data; the ML data indicates model management data and training data; the model management data indicates at least one of: a number of antennas or a number of retransmissions; and the training data indicates at least one of: a network UE load, an event threshold, or L1 and L2 measurements.

In some aspects, the at least one UE corresponds to a first UE and a second UE; and the first UE and the second UE requiring same ML data inputs or controls associated with at least one of: the at least one MLFN, an ML model ID, or a MS ID.

In some aspects, the ML data is transmitted to the first UE and the second UE via at least one of: a SIB or a MBS.

In some aspects, the at least one UE corresponds to a first UE; and the ML data is transmitted to the first UE via a unicast message.

In some aspects, the method 900 further includes receiving an indication using a MAC-CE, UAI, or UCI from the first UE to activate or deactivate transmission of the ML data to the first UE. In some cases, the operations of this step refer to, or may be performed by, circuitry for receiving and/or code for receiving as described with reference to FIG. 13.

In some aspects, the at least one UE corresponds to a first UE. In some aspects, the method 900 further includes receiving a request for the ML data from the first UE. In some cases, the operations of this step refer to, or may be performed by, circuitry for receiving and/or code for receiving as described with reference to FIG. 13. In some aspects, the ML data is transmitted to the first UE in response to the request.

In some aspects, the request is received via at least one of: UAI or a subscribe request.

In some aspects, the request indicates at least one of: the at least one MLFN; an ML model ID; a MS ID; geographical information comprising at least one of: current geographical area of the first UE, a PLMN, cell information, or a frequency list; a validity time comprising at least one of: a duration time or an interval time at which the ML data has to be provided to the first UE; one or more network configurations; or a type of the ML data comprising at least one of: meta data, training data, or inference data.

In some aspects, the method 900 further includes receiving an indication from the first UE to activate or deactivate transmission of the ML data to the first UE. In some cases, the operations of this step refer to, or may be performed by, circuitry for receiving and/or code for receiving as described with reference to FIG. 13.

In some aspects, the method 900 further includes transmitting the request to another network entity when one or more conditions are satisfied. In some cases, the operations of this step refer to, or may be performed by, circuitry for transmitting and/or code for transmitting as described with reference to FIG. 13.

In some aspects, the request is transmitted during a handover from one network entity to another network entity; and the one or more conditions are satisfied when the first UE moves from a connected state to an idle or inactive state or vice-versa.

In one aspect, method 900, or any aspect related to it, may be performed by an apparatus, such as communications device 1300 of FIG. 13, which includes various components operable, configured, or adapted to perform the method 900. Communications device 1300 is described below in further detail.

Note that FIG. 9 is just one example of a method, and other methods including fewer, additional, or alternative steps are possible consistent with this disclosure.

Aspects Related to UE-Based Machine Learning (ML) Data Input

Aspects of the present disclosure provide apparatuses, methods, processing systems, and computer-readable mediums for user equipment (UE)-based machine learning (ML) data input configuration and reporting.

For example, techniques proposed herein provide signaling designs for the UE-based ML data input configuration and reporting. In one example, UE-based ML data signaled by the UE to the network entity may assist in operation of ML model at the network entity. In another example, UE-based ML training data signaled by the UE to the network entity may assist in labelling UE-based ML training data at the network entity. The signaling techniques proposed herein are able to assist in operation and/or training of the ML model at the network entity.

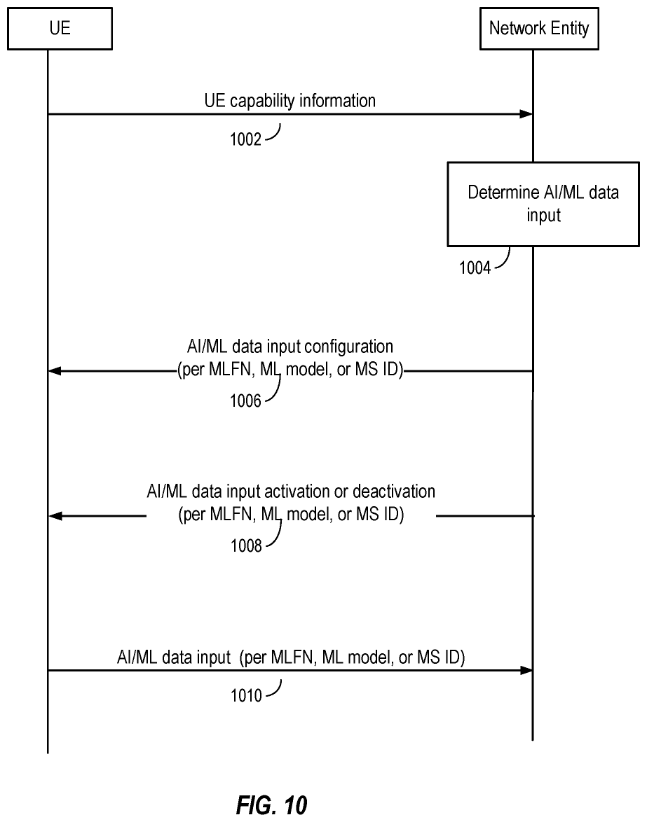

The techniques proposed herein may be understood with reference to the FIGS. 10-12.

FIG. 10 depicts a process flow for communications between a network entity and a UE. In some aspects, the network entity may be an example of the BS 102 depicted and described with respect to FIGS. 1 and 3 or a disaggregated BS depicted and described with respect to FIG. 2. Similarly, the UE may be an example of UE 104 depicted and described with respect to FIGS. 1 and 3. However, in other aspects, UE 104 may be another type of wireless communications device and BS 102 may be another type of network entity or network node, such as those described herein.

At 1002, the UE transmits UE capability information to the network entity.

At 1004, the network entity determines AI/ML data input. For example, the network entity may determine the AI/ML data input (e.g., per MLFN, ML model ID, or MS ID) based on the UE capability information.

At 1006, the network entity transmits AI/ML data input configuration to the UE. For example, the network entity may transmit AI/ML data input reporting configuration per MLFN, ML model ID, or MS ID to the UE.

At 1008, the network entity transmits AI/ML data input activation or deactivation indication to the UE. The network entity may transmit the AI/ML data input activation or deactivation indication via downlink control information (DCI). In one example, the network entity may send the indication to activate transmission of the AI/ML data input from the UE to the network entity, based on one or more first requirements of the network entity. In another example, the network entity may send the indication to deactivate transmission of the AI/ML data input from the UE to the network entity, based on one or more second requirements of the network entity.

At 1010, the UE transmits AI/ML data input to the network entity. For example, the UE may transmit the AI/ML data input to the network entity, in accordance with the AI/ML data input reporting configuration. The network entity may use the received AI/ML data as an input for operation and/or training of ML model.

FIG. 11 shows an example of a method 1100 for wireless communications by a UE, such as UE 104 of FIGS. 1 and 3.

Method 1100 begins at step 1105 with transmitting UE capability information to a network entity. In some cases, the operations of this step refer to, or may be performed by, circuitry for transmitting and/or code for transmitting as described with reference to FIG. 13.

Method 1100 then proceeds to step 1110 with receiving from the network entity a configuration for at least one MLFN and a request for ML data associated with the at least one MLFN to be used as an input for at least one of: operation or training of an ML model associated with the at least one MLFN, wherein the configuration and the request are based on the UE capability information. In some cases, the operations of this step refer to, or may be performed by, circuitry for receiving and/or code for receiving as described with reference to FIG. 13.

Method 1100 then proceeds to step 1115 with transmitting the ML data to the network entity in response to the request. In some cases, the operations of this step refer to, or may be performed by, circuitry for transmitting and/or code for transmitting as described with reference to FIG. 13.

In some aspects, the configuration further indicates at least one of: an ML model ID or a MS ID.

In some aspects, the method 1100 further includes receiving, via a MAC-CE or a DCI, an indication from the network entity to activate or deactivate transmission of the ML data to the network entity. In some cases, the operations of this step refer to, or may be performed by, circuitry for receiving and/or code for receiving as described with reference to FIG. 13.

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

FIG. 12 shows an example of a method 1200 for wireless communications by a network entity, such as BS 102 of FIGS. 1 and 3, or a disaggregated BS as discussed with respect to FIG. 2.

Method 1200 begins at step 1205 with receiving UE capability information from a UE. In some cases, the operations of this step refer to, or may be performed by, circuitry for receiving and/or code for receiving as described with reference to FIG. 13.

Method 1200 then proceeds to step 1210 with transmitting to the UE a configuration for at least one MLFN and a request for ML data associated with the at least one MLFN to be used as an input for at least one of: operation or training of an ML model associated with the at least one MLFN, wherein the configuration and the request are based on the UE capability information. In some cases, the operations of this step refer to, or may be performed by, circuitry for transmitting and/or code for transmitting as described with reference to FIG. 13.

Method 1200 then proceeds to step 1215 with receiving the ML data from the UE in response to the request. In some cases, the operations of this step refer to, or may be performed by, circuitry for receiving and/or code for receiving as described with reference to FIG. 13.

In some aspects, the configuration further indicates at least one of: an ML model ID or a MS ID.

In some aspects, the method 1200 further includes transmitting an indication via a MAC-CE or a DCI to the UE to activate or deactivate transmission of the ML data to the network entity. In some cases, the operations of this step refer to, or may be performed by, circuitry for transmitting and/or code for transmitting as described with reference to FIG. 13.

In some aspects, the method 1200 further includes determining the ML data to be reported based on the UE capability information. In some cases, the operations of this step refer to, or may be performed by, circuitry for determining and/or code for determining as described with reference to FIG. 13.

In one aspect, method 1200, or any aspect related to it, may be performed by an apparatus, such as communications device 1300 of FIG. 13, which includes various components operable, configured, or adapted to perform the method 1200. Communications device 1300 is described below in further detail.

Note that FIG. 12 is just one example of a method, and other methods including fewer, additional, or alternative steps are possible consistent with this disclosure.

### Example Communications Device

FIG. 13 depicts aspects of an example communications device 1300. In some aspects, communications device 1300 is a user equipment, such as UE 104 described above with respect to FIGS. 1 and 3. In some aspects, communications device 1300 is a network entity, such as BS 102 of FIGS. 1 and 3, or a disaggregated BS as discussed with respect to FIG. 2.

The communications device 1300 includes a processing system 1305 coupled to the transceiver 1365 (e.g., a transmitter and/or a receiver). In some aspects (e.g., when communications device 1300 is a network entity), processing system 1305 may be coupled to a network interface 1375 that is configured to obtain and send signals for the communications device 1300 via communication link(s), such as a backhaul link, midhaul link, and/or fronthaul link as described herein, such as with respect to FIG. 2. The transceiver 1365 is configured to transmit and receive signals for the communications device 1300 via the antenna 1370, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code) that when executed by the one or more processors 1310, cause the one or more processors 1310 to perform: the method 800 described with respect to FIG. 8, or any aspect related to it; the method 900 described with respect to FIG. 9, or any aspect related to it; the method 1100 described with respect to FIG. 11, or any aspect related to it; and/or the method 1200 described with respect to FIG. 12, or any aspect related to it. Note that reference to a processor performing a function of communications device 1300 may include one or more processors 1310 performing that function of communications device 1300.

In the depicted example, computer-readable medium/memory 1335 stores code (e.g., executable instructions), such as code for receiving 1340, code for using 1345, code for transmitting 1350, and code for determining 1355. Processing of the code for receiving 1340, code for using 1345, code for transmitting 1350, and code for determining 1355 may cause the communications device 1300 to perform: the method 800 described with respect to FIG. 8, or any aspect related to it; the method 900 described with respect to FIG. 9, or any aspect related to it; the method 1100 described with respect to FIG. 11, or any aspect related to it; and/or the method 1200 described with respect to FIG. 12, or any aspect related to it.

The one or more processors 1310 include circuitry configured to implement (e.g., execute) the code stored in the computer-readable medium/memory 1335, including circuitry such as circuitry for receiving 1315, circuitry for using 1320, circuitry for transmitting 1325, and circuitry for determining 1330. Processing with circuitry for receiving 1315, circuitry for using 1320, circuitry for transmitting 1325, and circuitry for determining 1330 may cause the communications device 1300 to perform: the method 800 described with respect to FIG. 8, or any aspect related to it; the method 900 described with respect to FIG. 9, or any aspect related to it; the method 1100 described with respect to FIG. 11, or any aspect related to it; and/or the method 1200 described with respect to FIG. 12, or any aspect related to it.

Various components of the communications device 1300 may provide means for performing: the method 800 described with respect to FIG. 8, or any aspect related to it; the method 900 described with respect to FIG. 9, or any aspect related to it; the method 1100 described with respect to FIG. 11, or any aspect related to it; and/or the method 1200 described with respect to FIG. 12, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1265 and the antenna 1270 of the communications device 1300 in FIG. 13. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1365 and the antenna 1370 of the communications device 1300 in FIG. 13.

### Example Clauses

Implementation examples are described in the following numbered clauses:

Clause 1: A method for wireless communications by a UE, comprising: receiving a configuration for at least one MLFN; receiving ML data associated with the at least one MLFN; and using the ML data as an input for at least one of: operation or training of an ML model associated with the at least one MLFN.

Clause 2: The method of Clause 1, wherein: the operation of the ML model comprises at least one of: running the ML model, switching the ML model, or monitoring the ML model; and the training of the ML model comprises: labeling the ML data for a particular UE and network entity setting or configuration and performing the training of the ML model using the labeled ML data.

Clause 3: The method of any one of Clauses 1 and 2, wherein: the ML data comprises the ML data comprises model management data and training data; the model management data indicates at least one of: a number of antennas or a number of retransmissions; and the training data indicates at least one of: a network load, an event threshold, or layer 1 (L1) and layer 2 (L2) measurements.

Clause 4: The method of any one of Clauses 1-3, wherein: the ML data is applicable for one or more other UEs in a network entity coverage or target area, and the ML data indicates at least one of: an ML model ID or a MS ID together with the ML data.

Clause 5: The method of Clause 4, wherein the ML data is received via at least one of: a SIB or MBS over MBS channel.

Clause 6: The method of any one of Clauses 1-5, wherein the ML data is received via a unicast message when at least one condition is satisfied: the UE connects to a network entity; or the UE is configured with at least one of: the at least one MLFN, an ML model ID, or a MS ID.

Clause 7: The method of Clause 6, further comprising: transmitting an indication using a MAC-CE, UAI, or UCI to the network entity to activate or deactivate transmission of the ML data to the UE.

Clause 8: The method of any one of Clauses 1-7, further comprising: transmitting a request to a network entity for the ML data, wherein the ML data is received by the UE in response to the request.

Clause 9: The method of Clause 8, wherein the transmitting comprises transmitting the request via at least one of: UAI or a subscribe request.

Clause 10: The method of Clause 8, wherein the request indicates at least one of: the at least one MLFN; an ML model ID; a MS ID; geographical information comprising at least one of: current geographical area of the UE, a PLMN, cell information, or a frequency list; a validity time comprising at least one of: a duration time or an interval time at which the ML data has to be provided to the UE; one or more network configurations or settings; or a type of the ML data comprising at least one of: meta data, training data, or inference data.

Clause 11: The method of Clause 8, further comprising: transmitting an indication using a MAC-CE, UAI, or UCI to the network entity to activate or deactivate transmission of the ML data to the UE.

Clause 12: A method for wireless communications by a network entity, comprising: transmitting a configuration for at least one MLFN to at least one UE; determining ML data associated with the at least one MLFN to be used as an input for at least one of: operation or training of an ML model associated with the at least one MLFN; and transmitting the ML data to the at least one UE.

Clause 13: The method of Clause 12, wherein: the operation of the ML model comprises at least one of: running the ML model, switching the ML model, or monitoring the ML model; the training of the ML model comprises labeling the ML data for a particular UE and network entity setting or configuration and performing the training of the ML model using the labeled ML data; the ML data indicates model management data and training data; the model management data indicates at least one of: a number of antennas or a number of retransmissions; and the training data indicates at least one of: a network UE load, an event threshold, or layer 1 (L1) and layer 2 (L2) measurements.

Clause 14: The method of any one of Clauses 12 and 13, wherein: the at least one UE corresponds to a first UE and a second UE; and the first UE and the second UE requiring same ML data inputs or controls associated with at least one of: the at least one MLFN, an ML model ID, or a MS ID.

Clause 15: The method of Clause 14, wherein the ML data is transmitted to the first UE and the second UE via at least one of: a SIB or a MBS.

Clause 16: The method of any one of Clauses 12-15, wherein: the at least one UE corresponds to a first UE; and the ML data is transmitted to the first UE via a unicast message.

Clause 17: The method of Clause 16, further comprising: receiving an indication using a MAC-CE, UAI, or UCI from the first UE to activate or deactivate transmission of the ML data to the first UE.

Clause 18: The method of any one of Clauses 12-17, wherein: the at least one UE corresponds to a first UE; receiving a request for the ML data from the first UE, wherein the ML data is transmitted to the first UE in response to the request.

Clause 19: The method of Clause 18, wherein the request is received via at least one of: UAI or a subscribe request.

Clause 20: The method of Clause 18, wherein the request indicates at least one of: the at least one MLFN; an ML model ID; a MS ID; geographical information comprising at least one of: current geographical area of the first UE, a PLMN, cell information, or a frequency list; a validity time comprising at least one of: a duration time or an interval time at which the ML data has to be provided to the first UE; one or more network configurations; or a type of the ML data comprising at least one of: meta data, training data, or inference data.

Clause 21: The method of Clause 18, further comprising: receiving an indication from the first UE to activate or deactivate transmission of the ML data to the first UE.

Clause 22: The method of Clause 18, further comprising: transmitting the request to another network entity when one or more conditions are satisfied.

Clause 23: The method of Clause 22, wherein: the request is transmitted during a handover from one network entity to another network entity; and the one or more conditions are satisfied when the first UE moves from a connected state to an idle or inactive state or vice-versa.

Clause 24: A method for wireless communications by a UE, comprising: transmitting UE capability information to a network entity; receiving from the network entity a configuration for at least one MLFN and a request for ML data associated with the at least one MLFN to be used as an input for at least one of: operation or training of an ML model associated with the at least one MLFN, wherein the configuration and the request are based on the UE capability information; and transmitting the ML data to the network entity in response to the request.

Clause 25: The method of Clause 24, wherein the configuration further indicates at least one of: an ML model ID or a MS ID.

Clause 26: The method of any one of Clauses 24-25, further comprising: receiving, via a MAC-CE or a DCI, an indication from the network entity to activate or deactivate transmission of the ML data to the network entity.

Clause 27: A method for wireless communications by a network entity, comprising: receiving UE capability information from a UE; transmitting to the UE a configuration for at least one MLFN and a request for ML data associated with the at least one MLFN to be used as an input for at least one of: operation or training of an ML model associated with the at least one MLFN, wherein the configuration and the request are based on the UE capability information; and receiving the ML data from the UE in response to the request.

Clause 28: The method of Clause 27, wherein the configuration further indicates at least one of: an ML model ID or a MS ID.

Clause 29: The method of any one of Clauses 27-28, further comprising: transmitting an indication via a MAC-CE or a DCI to the UE to activate or deactivate transmission of the ML data to the network entity.

Clause 30: The method of any one of Clauses 27-29, further comprising: determining the ML data to be reported based on the UE capability information.

Clause 31: An apparatus, comprising: a memory comprising executable instructions; and a processor configured to execute the executable instructions and cause the apparatus to perform a method in accordance with any one of Clauses 1-30.

Clause 32: An apparatus, comprising means for performing a method in accordance with any one of Clauses 1-30.

Clause 33: A non-transitory computer-readable medium comprising executable instructions that, when executed by a processor of an apparatus, cause the apparatus to perform a method in accordance with any one of Clauses 1-30.

Clause 34: A computer program product embodied on a computer-readable storage medium comprising code for performing a method in accordance with any one of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) configured for wireless communications, comprising:
a memory comprising computer-executable instructions; and
a processor configured to execute the computer-executable instructions and cause the UE to:
receive a configuration for at least one machine learning function name (MLFN);
receive machine learning (ML) data associated with the at least one MLFN; and
use the ML data as an input for at least one of: operation or training of an ML model associated with the at least one MLFN.

2. The UE of claim 1, wherein:
the operation of the ML model comprises at least one of: running the ML model, switching the ML model, or monitoring the ML model; and
the training of the ML model comprises: labeling the ML data for a particular UE and network entity setting or configuration, and performing the training of the ML model using the labeled ML data.

3. The UE of claim 1, wherein:
the ML data comprises model management data and training data;
the model management data indicates at least one of: a number of antennas or a number of retransmissions; and
the training data indicates at least one of: a network load, an event threshold, or layer 1 (L1) and layer 2 (L2) measurements.

4. The UE of claim 1, wherein:
the ML data is applicable for one or more other UEs in a network entity coverage or target area, and
the ML data indicates at least one of: an ML model identification (ID) or a model structure (MS) ID together with the ML data.

5. The UE of claim 4, wherein the ML data is received via at least one of: a system information block (SIB) or multicast broadcast service (MBS) over MBS channel.

6. The UE of claim 1, wherein the ML data is received via a unicast message when at least one condition is satisfied:
the UE connects to a network entity; or
the UE is configured with at least one of: the at least one MLFN, an ML model identification (ID), or a model structure (MS) ID.

7. The UE of claim 6, wherein the processor is further configured to execute the computer-executable instructions and cause the UE to: transmit an indication using a medium access control (MAC) control element (CE), UE assistance information (UAI), or uplink control information (UCI) to the network entity to activate or deactivate transmission of the ML data to the UE.

8. The UE of claim 1, wherein the processor is further configured to execute the computer-executable instructions and cause the UE to:
transmit a request to a network entity for the ML data, wherein the ML data is received by the UE in response to the request.

9. The UE of claim 8, wherein the transmit comprises transmit the request via at least one of: UE assistance information (UAI) or a subscribe request.

10. The UE of claim 8, wherein the request indicates at least one of:
the at least one MLFN;
an ML model identification (ID);
a model structure (MS) ID;
geographical information comprising at least one of: current geographical area of the UE, a public land mobile network (PLMN), cell information, or a frequency list;
a validity time comprising at least one of: a duration time or an interval time at which the ML data has to be provided to the UE;
one or more network configurations or settings; or
a type of the ML data comprising at least one of: meta data, training data, or inference data.

11. The UE of claim 8, wherein the processor is further configured to execute the computer-executable instructions and cause the UE to: transmit an indication using a medium access control (MAC) control element (CE), UE assistance information (UAI), or uplink control information (UCI) to the network entity to activate or deactivate transmission of the ML data to the UE.

12. A network entity configured for wireless communications, comprising:
a memory comprising computer-executable instructions; and
a processor configured to execute the computer-executable instructions and cause the network entity to:
transmit a configuration for at least one machine learning function name (MLFN) to at least one user equipment (UE);
determine machine learning (ML) data associated with the at least one MLFN to be used as an input for at least one of: operation or training of an ML model associated with the at least one MLFN; and
transmit the ML data to the at least one UE.

13. The network entity of claim 12, wherein:
the operation of the ML model comprises at least one of: running the ML model, switching the ML model, or monitoring the ML model; the training of the ML model comprises labeling the ML data for a particular UE and network entity setting or configuration and performing the training of the ML model using the labeled ML data;
the ML data indicates model management data and training data;
the model management data indicates at least one of: a number of antennas or a number of retransmissions; and
the training data indicates at least one of: a network UE load, an event threshold, or layer 1 (L1) and layer 2 (L2) measurements.

14. The network entity of claim 12, wherein:
the at least one UE corresponds to a first UE and a second UE; and
the first UE and the second UE requiring same ML data inputs or controls associated with at least one of: the at least one MLFN, an ML model identification (ID), or a model structure (MS) ID.

15. The network entity of claim 14, wherein the ML data is transmitted to the first UE and the second UE via at least one of: a system information block (SIB) or a multicast broadcast service (MBS).

16. The network entity of claim 12, wherein:
the at least one UE corresponds to a first UE; and
the ML data is transmitted to the first UE via a unicast message.

17. The network entity of claim 16, wherein the processor is further configured to execute the computer-executable instructions and cause the network entity to: receive an indication using a medium access control (MAC) control element (CE), UE assistance information (UAI), or uplink control information (UCI) from the first UE to activate or deactivate transmission of the ML data to the first UE.

18. The network entity of claim 12, wherein:
the at least one UE corresponds to a first UE;
the processor is further configured to execute the computer-executable instructions and cause the network entity to: receive a request for the ML data from the first UE, wherein the ML data is transmitted to the first UE in response to the request.

19. The network entity of claim 18, wherein the request is received via at least one of: UE assistance information (UAI) or a subscribe request.

20. The network entity of claim 18, wherein the request indicates at least one of:
the at least one MLFN;
an ML model identification (ID);
a model structure (MS) ID;
geographical information comprising at least one of: current geographical area of the first UE, a public land mobile network (PLMN), cell information, or a frequency list;
a validity time comprising at least one of: a duration time or an interval time at which the ML data has to be provided to the first UE;
one or more network configurations; or
a type of the ML data comprising at least one of: meta data, training data, or inference data.

21. The network entity of claim 18, wherein the processor is further configured to execute the computer-executable instructions and cause the network entity to: receive an indication from the first UE to activate or deactivate transmission of the ML data to the first UE.

22. The network entity of claim 18, wherein the processor is further configured to execute the computer-executable instructions and cause the network entity to: transmit the request to another network entity when one or more conditions are satisfied.

23. The network entity of claim 22, wherein:
the request is transmitted during a handover from one network entity to another network entity; and
the one or more conditions are satisfied when the first UE moves from a connected state to an idle or inactive state or vice-versa.

24. A user equipment (UE) configured for wireless communications, comprising:
a memory comprising computer-executable instructions; and
a processor configured to execute the computer-executable instructions and cause the UE to:
transmit UE capability information to a network entity;
receive from the network entity a configuration for at least one machine learning function name (MLFN) and a request for machine learning (ML) data associated with the at least one MLFN to be used as an input for at least one of: operation or training of an ML model associated with the at least one MLFN, wherein the configuration and the request are based on the UE capability information; and
transmit the ML data to the network entity in response to the request.

25. The UE of claim 24, wherein the configuration further indicates at least one of: an ML model identification (ID) or a model structure (MS) ID.

26. The UE of claim 24, wherein the processor is further configured to execute the computer-executable instructions and cause the UE to: receive, via a medium access control (MAC) control element (CE) or a downlink control information (DCI), an indication from the network entity to activate or deactivate transmission of the ML data to the network entity.

27. A network entity configured for wireless communications, comprising:
a memory comprising computer-executable instructions; and
a processor configured to execute the computer-executable instructions and cause the network entity to:
receive user equipment (UE) capability information from a UE;
transmit to the UE a configuration for at least one machine learning function name (MLFN) and a request for machine learning (ML) data associated with the at least one MLFN to be used as an input for at least one of: operation or training of an ML model associated with the at least one MLFN, wherein the configuration and the request are based on the UE capability information; and
receive the ML data from the UE in response to the request.

28. The network entity of claim 27, wherein the configuration further indicates at least one of: an ML model identification (ID) or a model structure (MS) ID.

29. The network entity of claim 27, wherein the processor is further configured to execute the computer-executable instructions and cause the network entity to: transmit an indication via a medium access control (MAC) control element (CE) or a downlink control information (DCI) to the UE to activate or deactivate transmission of the ML data to the network entity.

30. The network entity of claim 27, wherein the processor is further configured to execute the computer-executable instructions and cause the network entity to: determine the ML data to be reported based on the UE capability information.
